(19) United States
(12) Patent Application Publication
(10) Pub. No.: US 2007/0272330 A1
(43) Pub. Date: Nov. 29, 2007

(54) SPIRAL PROFILE CUTTING TOOL

(76) Inventors: Philippe Turcot, Mont-St-Hilaire (CA); Gabriel Fafard, St-Hubert (CA); Yvon Gauthier, McMasterville (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/682,446

(22) Filed: Mar. 6, 2007

Related U.S. Application Data
(60) Provisional application No. 60/799,352, filed on May 11, 2006.

(51) Int. Cl. B27C 5/00

(52) U.S. Cl. 144/221; 29/557

(57) ABSTRACT

A spiral profile cutting tool for cutting a profile in a wood piece comprises a body defining an axis of rotation. Typically, at least two cutting blades are provided on the body. The cutting blades extend radially from the body about the axis of rotation in a spiral formation and have a variable radius defining a cutting profile for shaping a profile in the wood piece.

### RELATED APPLICATIONS

This application claims priority from U.S. Provisional Patent Application No. 60/799,352 filed May 11, 2006.

### BACKGROUND OF THE INVENTION

1. Field of the Invention

The present invention relates generally to the field of cutting tools, and more particularly, to cutting tools for cutting profile surfaces in wood pieces and the like.

2. Description of the Prior Art

Presently known cutting tools for cutting a profile surface in a wood piece have a number of disadvantages associated therewith. A profile surface in a wood piece is desirable for cabinet doors and tables to name a few. Wood planks that are suited for making cabinet doors or tables require the cutting tools to work both with and against the grain of the wood. Conventional cutting tools for such applications are unable to yield similar results between working with the grain and working against the grain. Particularly, the cut against the grain is of lower quality which becomes problematic during wood staining. The lower quality profile surface that is cut against the grain absorbs the stain better than the profile surface that is cut with the grain. Thus, the wood piece is not uniformly stained. To compensate for the darker stained regions, the latter are sanded to achieve a more uniform color. The step of sanding is generally done manually which lengthens the manufacturing time and brings up the overall costs.

Therefore, there exists a need for a cutting tool that can cut a profile surface in a wood piece both with and against the grain with improved results.

### SUMMARY OF THE INVENTION

It is therefore an aim of the present invention to provide an improved cutting tool for cutting profile surfaces in a workpiece.

In one aspect, the present invention provides a spiral profile cutting tool for cutting a profile in a workpiece comprising: a body defining an axis of rotation, at least two cutting blades each having a cutting face, the cutting blades extending radially from the body about the axis of rotation in a spiral formation and having a variable radius defining a cutting profile for shaping a profile in the workpiece.

In another aspect, the present invention provides a spiral profile cutting tool of a wood cutting machine comprising a body defining an axis of rotation having a cutting spiral extending along a variable radius about the axis of rotation, the cutting spiral extending between a first and a second radius, the first radius being greater than the second radius, the cutting spiral forming a profile shape in the axial direction adapted for cutting a profile surface in a wood piece.

Further details of these and other aspects of the present invention will be apparent from the detailed description and figures included below.

### BRIEF DESCRIPTION OF THE DRAWINGS

Reference will now be made to the accompanying drawings, showing by way of illustration a preferred embodiment thereof, and in which:

FIG. 1 is a perspective view of a spiral profile cutting tool in accordance with a preferred embodiment of the present invention, shown cutting a profile surface in a wood piece;

FIG. 2 is a bottom view of the spiral profile cutting tool of FIG. 1, showing four cutting blades extending in a spiral formation along a varying radial distance;

FIG. 3 is a side view in section of the spiral profile cutting tool taken along cross section A-A of FIG. 2, shown cutting a profile surface in a wood piece;

FIG. 4 is a perspective side view of a spiral profile cutting tool in accordance with another embodiment of the present invention; shown cutting a profile surface in a wood piece;

FIG. 5 is a schematic view of tool turning body used to generate the cutting spiral that will be able to provide the illustrate wood's profile; and

FIG. 6 a bottom plan view of the tool turning body illustrating how the cutting spiral is generated.

### DESCRIPTION OF THE PREFERRED EMBODIMENTS

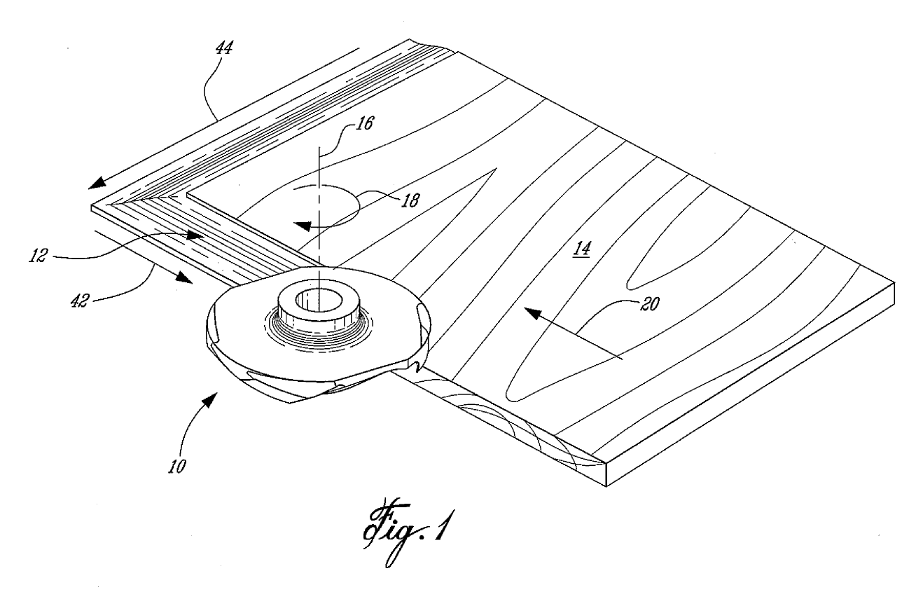

FIG. 1 generally illustrates a spiral profile cutting tool 10 in accordance with a particular embodiment of the present invention, shown cutting a profile surface 12 into a wood piece 14. The spiral profile cutting tool 10 is adapted to be mounted to a cutting machine (not shown). The spiral profile cutting tool 10 defines an axis of rotation 16 and is shown rotating about the axis of rotation 16 in a clockwise direction (CW) 18. A feed direction of the wood piece 14 relative to the spiral profile cutting tool 10 is identified by arrow 20.

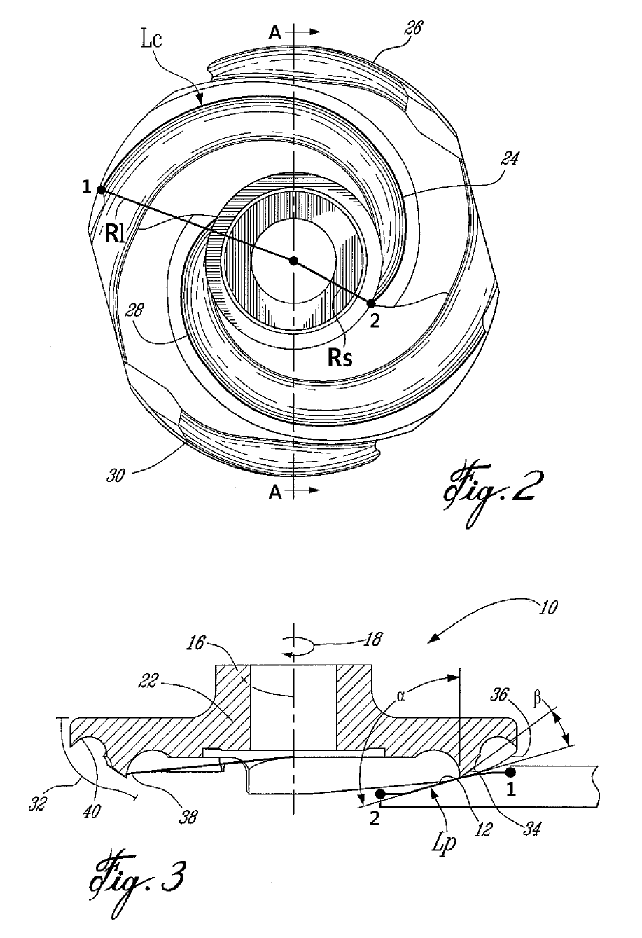

Referring concurrently to FIGS. 2 and 3, it can be seen that the spiral profile cutting tool 10 comprises a body 22 having an axis of rotation 16. Four cutting blades 24-30 extend radially outward from the body 22 about the axis of rotation 16 in a spiral formation. The cutting blades 24-30 are disposed relative to one another so as to balance the spiral profile cutting tool 10, and more specifically cutting blade 24 is diametrically opposed to cutting blade 28 and cutting blade 26 is diametrically opposed to cutting blade 30. The use of at least two cutting blades is preferred in that it facilitates the manufacturing of a well rotationally balance cutting tool 10. It is noted that the tool could have an uneven number of cutting blades and that the blades. Also, the blades do not always have to be diametrically opposed to one another to be rotationally balanced.

Furthermore, the cutting blades 24-30 each have a variable radius from the axis of rotation 16, and more particularly, the cutting blades 24-30 each extend between a first radius and a second radius. As can be seen in FIG. 2, the first radius of cutting blade 24 is identified as Rₗ and the second radius is identified as Rₛ such that the first is larger than the second radius. In this embodiment, the cutting blades 24-30 extend in a smooth continuous spiral formation from the larger radius Rₗ to the smaller radius Rₛ along the height of the body 22; however, a person skilled in the art will recognize that the radius can be varied in other suitable ways.

Now referring to FIG. 3, it can be seen that the cutting blades 24-30 define a cutting portion 32 along the height of the body 22 in the axial direction for shaping a profile in a wood piece. In this particular embodiment, the cutting portion 32 is designed to particularly form the profile surface 12 as shown in wood piece 14. Notably, the profile surface 12 has multiple curves of varying slopes and lengths. A person skilled in the art will appreciate that the spiral profile cutting tool of the present invention can have any suitable cutting profile depending on the predetermined profile surface desired.

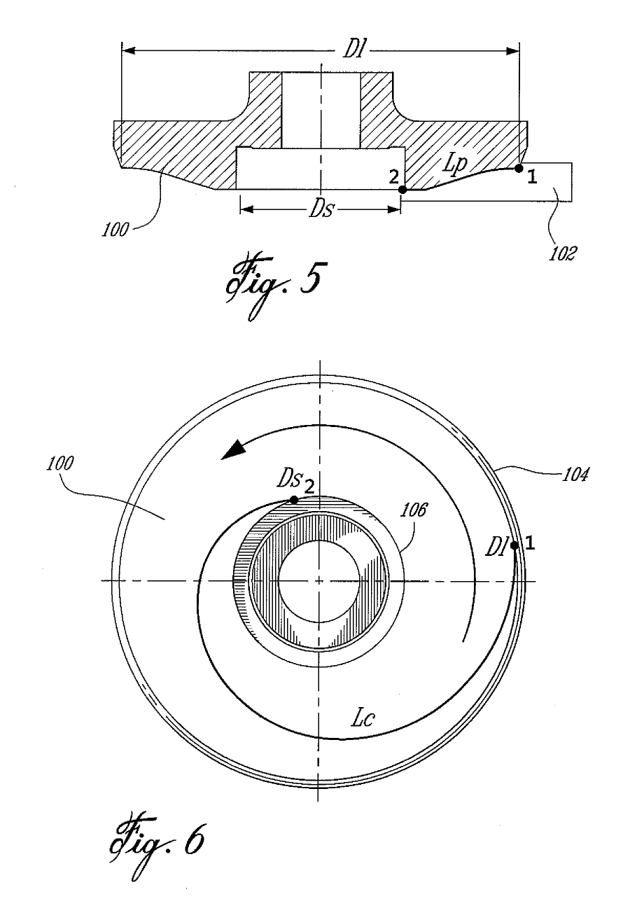

The cutting blades 24-30 have respective cutting faces 34-40 which define a shear angle λ (only shown with respect to the embodiment illustrated in FIG. 5) with the axis of rotation 16. The shear angle λ is constant along the cutting faces 34-40 and wide, varying between a range ≧45° and <90°. A wide or pronounced shear angle λ ensures that when the spiral profile cutting tool 10 is working against the grain as identified by arrow 42 in FIG. 1, the cutting blades 24-30 move almost with the natural wood grain orientation thereby yielding a high quality profile surface cut. When the spiral profile cutting tool 10 is working with the grain as identified by arrow 44 in FIG. 1, a wide shear angle λ also ensures that the wood fibres are cleanly cut without fuzzy or raised grains. When working only with the grain, the shear angle is preferably comprised between 45 and 60 degrees. When working only against the grain, the shear angle is preferably comprised between a range ≧60° and <90°. However, when it is desired to have a tool which will be used for both cutting with the grain and against the grain, then the shear angle λ is preferably comprised between 60 degrees and 80 degrees, a preferred value being about 70 degrees.

To correctly generate a wide and constant shear angle λ from a wood profile surface, firstly it is necessary to compute the Cutting Blade Length Lc in relation to the wood's Profile Length Lp as identified respectively in FIGS. 2 and 3 for cutting blade 24.

$$Lc = \frac{90 ° ⋆ Lp}{90 ° - λ}$$

For example, if the wood's Profile Length Lₚ is 50 mm and the desired shear angle λ is 75°, then the Cutting Blade Length Lc will be 300 mm. The Lc/Lp ratio will be 6:1 such that Cutting Blade Length Lc is 6 times longer than the wood Profile Length Lp. This is advantageous in that it provides for progressive smooth cutting. A long cutting blade is advantageous in that it provides for a better distribution of the efforts on the blade and, thus, prevents premature wear of the blade. With a shear angle λ from 60° to 80°, the Lc/Lp ratio varies from 3:1 to 9:1.

As exemplified for cutting blade 24 in FIG. 2, the cutting length (Lc) starts from the large cutting radius Rₗ at point 1 and ends at the small cutting radius Rₛ at point 2 complementing the height of the wood profile surface 12 between points 1 and 2 shown in FIG. 3. This generates a variable conical spiral curve or formation that follows the wood profile surface 12.

The cutting blades 24-30 extend about the axis of rotation 16 in a counter-clockwise direction which is opposite to the direction of rotation 18 of the spiral profile cutting tool 10. A person skilled in the art will appreciate that the opposite case is also possible.

The direction of the cutting blades 24-30 with respect to the direction of rotation 18 determines how wood chips generated during operation will be directed. To ensure that the cutting blades 24-30 conduct the wood chips downwardly towards the spiral profile cutting tool's axis of rotation 16 the aforementioned directions need to be opposite as is exemplified in the accompanying FIGS. 1-3. Thus, wood blow out is prevented when the spiral profile cutting tool 10 is cutting against the grain 42 as shown in FIG. 3. However, in the case where the cutting blades 24-30 extend about the axis of rotation 16 in the same direction as the spiral profile cutting tool 10 rotates, the wood chips are directed up and radially outwardly for evacuation.

Still referring to FIG. 3, it can be seen that the spiral profile cutting tool 10 defines a rake angle α and a back relief angle β. The rake angle α is the angle between the cutting faces 34-40 and the wood cut profile surface 12. The back relief angle β is the angle between the back relief face 46 of the cutting blades 24-30 and the wood cut profile surface 12. The rake angle a can range from 90° to 125° and the back relief angle β can range from 5° to 35°, depending on the design concept of the spiral profile cutting tool 10 and the type of wood or material to be cut. The rake angle α and the back relief angle β are preferably substantially constant all along the cutting blades 24-30. The rake angle α and a back relief angle β can be different from one blade to another for a same tool. For instance, blades 24 and 26 may have a different rake angle α and a different back relief angle β.

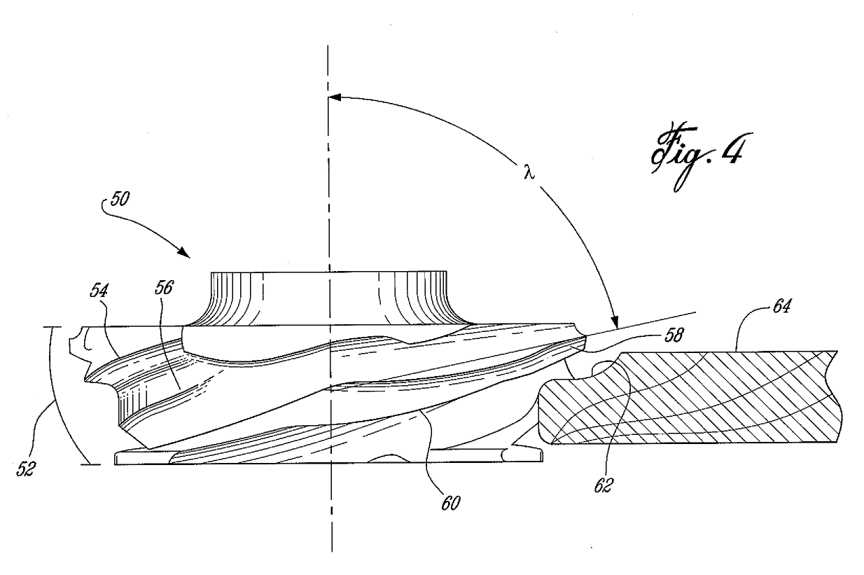

FIG. 4 exemplifies another possible embodiment of the spiral profile cutting tool 50 of the present invention having a different cutting profile 52 than the cutting portion 32 exemplified in FIG. 3. It can be seen that the cutting profile 52 is also defined by four cutting blades 54-60 that extend from a larger radius to a smaller radius so as to create a decreasing slope in the profile surface 62 towards the edge of wood piece 64. A person skilled in the art would recognize that the cutting profile design of the spiral profile cutting tool can be varied to produce changes in the profile surface of a wood piece.

In use, the spiral profile cutting tool 10 is powered to rotate about its axis of rotation 16 in the CW direction 18 by a wood cutting machine. As exemplified in FIG. 1, the wood piece 14 is fed in an opposing direction 20 to machine the top of one side of the perimeter of the wood piece. The spiral profile cutting tool 10 can cut into the wood piece 14 to form the profile surface 12 both with and against the grain 44,42 yielding similar finishing results. Two superimposed cutting movements are carried out by the cutting blades 24-30 during rotation due to the spiral formation: a tangential movement and an axial movement. The tangential movement causes a drawing cut while the axial movement carries out the wood chip transportation. Furthermore, the spiral formation allows for improved cutting blade engagement with the wood piece and a relatively smooth change in the cutting force thereby promoting a quiet operation of the spiral profile cutting tool 10.

The design of a spiral profile cutting tool typically starts from a predetermined profile defined in a workpiece. As shown in FIGS. 5 and 6, a tool turning body 100 intimately embracing or hugging the profile of a workpiece 102 is first built. The tool turning body 100 is rotated on top of the profile workpiece 102 and a first circle 104 having a radius corresponding to point 1 of the profile in FIG. 5 (i.e. a first end point of the profile) is first drawn on the bottom face of the turning body 100. A second circle 106 having a radius corresponding to point 2 of the profile in FIG. 5 (i.e. the second end point of the profile) is also drawn on the bottom face of the turning body 100. The circles 104 and 106 are centered relative to the axis of rotation of the tool turning body 100. Then, the length of the profile Lp between end points 1 and 2 is measured and the shear angle λ is set to a desired value. In this way, the cutting blade length Lc can be easily calculated using the formula presented above. Knowing the length Lc of the cutting blade, and knowing that the blade starts on an arbitrary point on the first circle and ends on the second circle, the variable conical spiral curve that follows the desired profile of the workpiece can be generated and drawn on the turning body as shown in FIG. 6. The cutting blade is then machined by following the predetermined conical spiral curve.

The above description is meant to be exemplary only, and one skilled in the art will recognize that changes may be made to the embodiments described without department from the scope of the invention disclosed. For example, the spiral profile cutting tool of the present invention may be used to cut a profile surface into the side of a wood piece or the like rather than the top thereof. Also, the tool could be provided with a single cutting spiral. This is more challenging to design in terms of dynamic balancing but still possible. Still other modifications which fall within the scope of the present invention will be apparent to those skilled in the art, in light of a review of this disclosure, and such modifications are intended to fall within the appended claims.

What is claimed is:

1. A spiral profile cutting tool for cutting a profile in a workpiece comprising: a body defining an axis of rotation, at least two cutting blades each having a cutting face, the cutting blades extending radially from the body about the axis of rotation in a spiral formation and having a variable radius defining a cutting profile for shaping a profile in the workpiece.

2. The spiral profile cutting tool of claim 1, wherein the cutting blades define a constant shear angle defined between the respective cutting faces and the axis of rotation.

3. The spiral profile cutting tool of claim 2, wherein the shear angle is in a range ≧45° and <90°.

4. The spiral profile cutting tool of claim 3, wherein said shear angle is in a range ≧60° and <80°.

5. The spiral profile cutting tool of claim 1, wherein the body has a height in the axial direction and the cutting profile being defined along the height.

6. The spiral profile cutting tool of claim 1, wherein the spiral formation is a variable conical spiral formation.

7. The spiral profile cutting tool of claim 1, wherein the cutting blades extend about the axis of rotation between a first radius and a second radius.

8. The spiral profile cutting tool of claim 7, wherein the first radius is greater than the second radius.

9. The spiral profile cutting tool of claim 1, wherein the cutting blades extend about the axis of rotation in a direction opposite a direction of rotation of the spiral profile cutting tool.

10. The spiral profile cutting tool of claim 1, wherein the cutting blades define a constant rake angle defined between the respective cutting faces and a cut surface of the workpiece.

11. A spiral profile cutting tool of a wood cutting machine comprising: a body defining an axis of rotation having a cutting spiral extending along a variable radius about the axis of rotation, the cutting spiral extending between a first and a second radius, the first radius being greater than the second radius, the cutting spiral forming a profile shape in the axial direction adapted for cutting a profile surface in a wood piece.

12. The spiral profile cutting tool of claim 11, wherein the tool comprises at least two cutting spiral, the cutting spirals having respective cutting faces and define a constant shear angle between the respective cutting faces and the axis of rotation.

13. The spiral profile cutting tool of claim 12, wherein the shear angle is in a range ≧60° and <80°.

14. The spiral profile cutting tool of claim 13, wherein said shear angle is about 70°.

15. A method of manufacturing a profile cutting tool, comprising providing a tool turning body having a face intimately embracing a profile defined in a workpiece, determining a length of the profile lp between end points P1 and P2, selecting a desired shear angle λ, calculating a corresponding cutting edge length using the following formula:
$$Lc = \frac{90 ° ⋆ Lp}{90 ° - λ}$$
and generating on the face of the tool turning body a spiral curve having a length Lc starting on a large diameter circle having a radius corresponding to end point P1 and ending on a small diameter circle having a radius corresponding to point P2.
